(19) United States
(12) Patent Application Publication
(10) Pub. No.: US 2004/0047941 A1
(43) Pub. Date: Mar. 11, 2004

(54) Blow molding machine having flexible cavitation

(76) Inventors: Leon G. Salenbien, Dundee, MI (US); Michelle M. Belin, Ann Arbor, MI (US); Terry C. Potter, Lambertville, MI (US); Peter J. Hatas, Sylvania, OH (US); James Potter, Livonia, MI (US); Liguo Zhao, Toledo, OH (US); J. Scott Rosenbeck, Jackson, MI (US); Robert Cooper, Grass Lake, MI (US)

Correspondence Address: Brinks Hofer, Gilson & Lione, PO Box 10395, Chicago, IL, 60610, US

(21) Appl. No.: 10/297,463

(22) PCT Filed: May 24, 2001
(86) PCT No.: PCT/US01/16996

(51) Int. Cl. B29C 49/64

(52) U.S. Cl. 425/526; 425/534

(57) ABSTRACT

A two-step blow molding machine (10) having flexible cavitation which includes a plurality of stations, a preform loading station (12), a thermal conditioning station (14) where preforms are heated and thermally conditioned prior to blow molding, a blow molding station (16) having a plurality of molds, the number of which defines the cavitation of the blow molding station, and an article unloader station (18). The machine includes a plurality of carriers (22) adapted to receive the preforms thereon at said preform loading station. The carriers are transported about the machine in an unrestrained manner where spacing of the carriers does not correspond with cavitation of the machine. First and second conveyors and associated drives convey the carriers at different rates. The first and second conveyors and their associated drivers are independently controllable from one another such that the first and second rates are independently variable which allows changeable cavitation.

### FIELD OF THE INVENTION

The present invention relates to a two-step blow molding machine and, more particularly, to such a machine having readily changeable or flexible cavitation.

### DESCRIPTION OF THE PRIOR ART

A two-step blow molding machine is an apparatus designed to produce plastic blow molded articles from a previously formed plastic preform. In the two-step machine, the previously formed preform is received by the machine and reheated to a temperature suitable for blow molding and, more specifically, stretch blow molding. Reheating of the preform is conducted in such a manner that the preform is conditioned to the proper temperature prior to being transferred to the blow molding station of the machine. In the blow molding station, a high pressure fluid medium is introduced into the interior of the preform and this, in conjunction with an axially extendable stretch rod, causes the preform to conform to the desired configuration as defined by the cavity surfaces of the molds themselves.

A two-step blow molding machine differs from a one-step blow molding machine in that a one-step machine, in addition to blow molding the preform into the resultant article, also forms the preform, typically by injection molding.

Two-step blow molding machines are typically of two styles, rotary and inline. In a rotary machine, preforms are received into the machine at one station, transferred to a second station by a rotary table or wheel where they are thermally conditioned. Next the table rotates to transfer the reheated preforms to the blow molding station.

As one skilled in the art will readily appreciate, the cavitation of such machines is fixed, meaning that the number of blow mold cavities cannot be changed without rebuilding or drastically changing the configuration or other stations in the machine. In rotary machines, the number of neck splits 9 which hold the preforms) correspond both in number and spacing with the cavitation of the machine. Additionally, the number of heating pots used at the thermal conditioning station likewise corresponds in number and spacing. If the cavitation of the machine is to be changed, not only must the mounting of the neck splits to the indexing table be changed, but also the number of and spacing of the conditioning pots, the transfer mechanism for loading preforms into the machine and the transfer mechanism for discharging the resultant articles from the machine.

Thus, when a blow molder desires to mold a larger diameter article, thereby necessitating a cavitation change, the blow molder must undertake a time consuming and expensive reconfiguration of the existing blow molding machine. Obviously, the expense and time does not lend itself to utilizing one machine for frequently switching between different cavitation requirements. As a result, blow molders typically buy a second or additional machine for each of their cavitation and article requirements.

Inline two-step blow molding machines typically use one of three constructions. In one approach, the preform is mounted on a preform holder which is itself secured to a chain conveyor at fixed intervals. As the chain conveyor rotates, the preforms are cycled through a thermal conditioning station and then into a blow molding station. The fixed spacing of the holders on the chain conveyor is determined by and corresponds with the cavitation of the blow molding station. Additional constructions of inline blow molding machines similarly fix the relative position of the preforms to one another, with the spacing corresponding to the spacing of the mold cavities.

The limitations recited above in connection with rotary machines similarly applies to inline blow molding machines. In changing over such machines, not only do the molds have to be changed themselves, but also numerous aspects with the respect to the holders of the preforms, the drive systems for moving the holders, and the conditions under which thermal conditioning occurs. For example, by changing cavitation it may cause an increase or decrease in the amount of time spent at the thermal conditioning station. Accordingly, the preform may be over or under heated resulting in an unacceptable article being molded at the blow molding station.

One attempt to modularize a blow molding machine is found in U.S. Pat. No. 4,151,876. This machine utilizes component dye sets having modular elements so that containers of different sizes can be molded without requiring complete dye sets of each individual container size. While this design offers some flexibility regarding the size of the containers the machine is capable of manufacturing, it is still limited to a fixed number of mold cavities located at fixed mold centerlines. The cavitation is actually fixed.

From the above, it is clearly seen that there exists a need for a blow molding machine having the ability to quickly and easily change the mold cavity spacing utilized in the machine.

In view of the above limitations and drawbacks of the prior art, it is the object of the present invention to provide a blow molding machine having flexible cavitation.

Another object of the present invention is to provide a blow molding machine in which preforms are carried in a manner that allows the cavitation of the machine to be changed without changing the manner and mechanism by which the preforms are carried about the machine.

### SUMMARY OF THE INVENTION

In overcoming the limitations of the prior art and achieving the above and other objects, the present invention provides a two-step blow molding machine having a novel construction which allows for the cavitation of the machine to be flexible. As used herein, references to a machine having flexible cavitation is intended to mean that the cavitation at the blow molding station of the machine can be changed, molds positioned on different mold centerlines, without requiring significant changes in the main other stations of the machine. With the present invention, changes to the other stations principally includes changing programmable control of those stations and in particular controlling the rate at which preforms are transferred through the various stations.

In accomplishing the above, the present invention provides a two-step blow molding machine having a plurality of stations including a preform loading station where preforms are loaded into the machine, a thermal conditioning station where preforms are heated to enable blow molding of the preforms, a blow molding station where the preforms are blow molded into articles, and an article unloading station where the articles are removed from the machine. In addition to the above, the machine includes a plurality of preform carriers which receive preforms at the preform loading station and are utilized to transport the preforms through each of the various stations of the machine. The machine further includes a first conveyor which transports the carriers and preforms through the thermal conditioning station at a first rate. A driver is associated with the first conveyor for controlling the rate of the first conveyor. A second conveyor and associated driver conveys the carriers and preforms from the thermal conditioning station to the blow molding station. The first and second conveyors with their associated drivers are independently controllable such that the conveyance rate of each conveyor can be independently varied with respect to the conveyance rate of the other.

By enabling this variance in conveyance rate of the carriers, and resultingly the preforms, through the conditioning station and to the blow molding station, the present invention enables the blow molding machine of the present invention to exhibit flexible cavitation as defined above.

In another aspect, the present invention provides a two-step blow molding machine in which the soak time, the time from exiting the thermal conditioning station until the time of blow molding, is variable. As such, the present invention in this aspect is a blow molding machine having a plurality of stations including a preform loading station for loading preforms into the machine, a thermal conditioning station where the preforms are thermally conditioned for blow molding, a blow molding station where the preforms are blow molded into articles, and an article unloading station where the articles are removed from the machine. The present invention in this aspect also includes a plurality of preform carriers which receive and carry the preforms at the preform loading station to transport the preforms through the blow molding machine. In this aspect, the present invention further includes a conveyor and associated driver which conveys the carriers with the preforms engaged thereon, from the thermal conditioning station to the blow molding station. The rate at which the conveyor and its associated driver conveyed the carriers from the thermal conditioning station to the blow molding station is variable such that the time from which the preforms emerge from the thermal conditioning station until they are taken into the blow molding station can be increased or decreased. The time is thus variable and this length of time is referred to as the soak time. The term soak time relates to the amount of time available for the temperature of the interior surface of the preform wall to equalize with the temperature of the exterior surface of the preform wall, as a result of the preform being heated through its exterior wall in the thermal conditioning station.

The above and other objects of the present invention will become apparent to one skilled in the art upon a reading of this specification, including the claims and with reference to the drawings.

### BRIEF DESCRIPTION OF THE DRAWINGS

FIG. 1 is a schematic illustration of a two-step blow molding machine according to the principles of the present invention.

FIG. 1A is a top plan view of a machine according to the present invention.

FIG. 2 is an isolated view of the conveyor and associated driver which transports the carriers from the preform loader to the thermal conditioning station and from the thermal conditioning station to the blow molding station.

FIG. 3 is a cross sectional view through one oven of the thermal conditioning station illustrating the heating elements of the oven as well as the various conveyor and rotational mechanisms utilized therein.

FIG. 4 is a top plan view of the thermal conditioning station with the housing and heating elements removed to illustrate the conveying mechanisms, as well as the positioning of the carriers and preforms relative to one before during and after entering the thermal conditioning station.

FIG. 5 is an enlarged view of the thermal conditioning station where carriers and preforms are staged prior to entry into the blow molding station.

FIG. 6 is a side elevational view of the station seen in FIG. 5.

FIG. 7 is a partial perspective view of the clamp assembly found in the blow molding station.

FIG. 8 is a partial perspective view of the stretch rod and blow assembly used in the blow molding station.

FIG. 9 is a top plane view of the mechanisms used to transfer carriers, preforms and/or articles between the blow molding station, the article unloading station and the preform loading station.

FIG. 10 is a partial side elevational view of the article unloading station and the preform loading station.

### DETAILED DESCRIPTION OF THE PREFERRED EMBODIMENTS

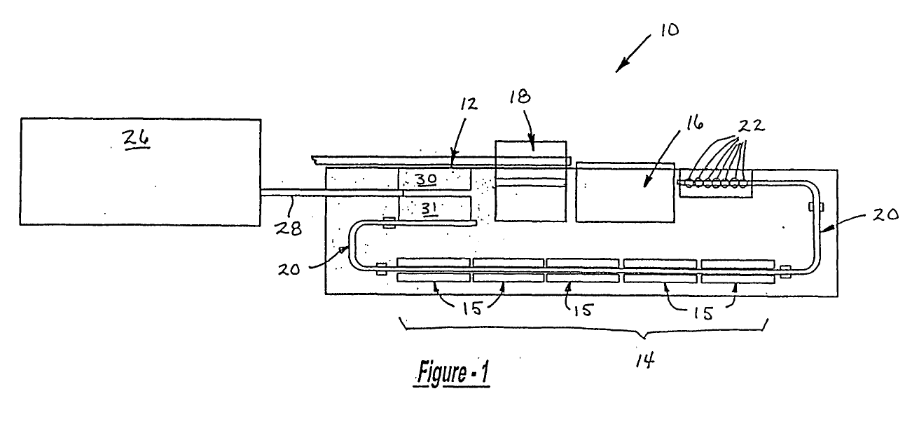

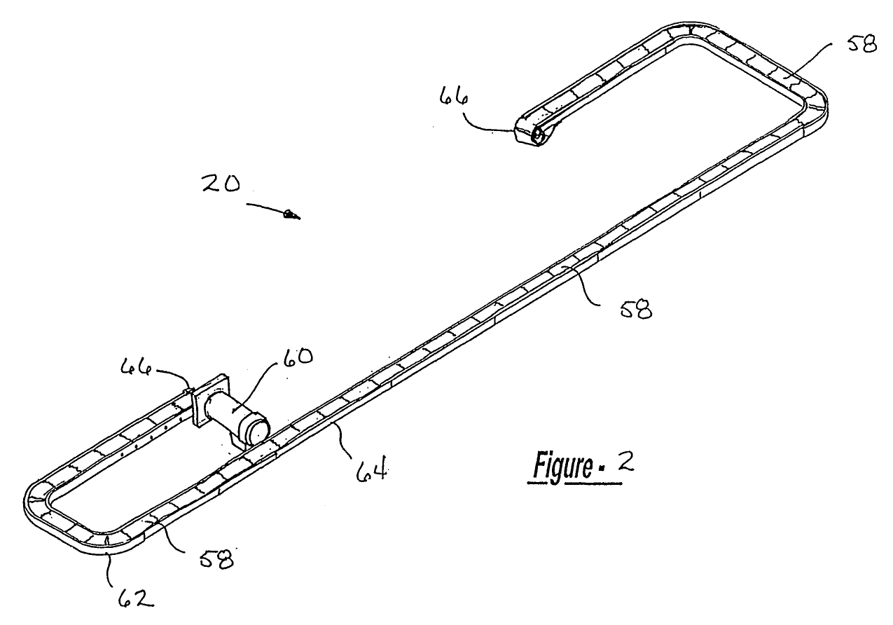

Referring now the drawings, seen diagrammatically in FIG. 1 is a two-step blow molding machine 10 according to the principles of the present invention. The machine is provided with a number of stations including a preform loading station 12, a thermal conditioning station 14, a blow molding station 16 and an article unloading station 18. In addition to the above stations, the machine 10 utilizes a transport conveyor 20 and carriers 22 to move the preforms 24 (seen in FIG. 3) from the preform loading station 12 to the blow molding station 16. The carriers 24 are additionally utilized in transfer of the preforms 24 into the blow molding station 16 and subsequently to the article unloading station 18. All of these features are further described below.

Preforms 24, are received in bulk at a preform feeder 26. The preform feeder 26 orients the preforms 24 in a consistent manner and delivers the preforms 24 via a guide rail 28 to the preform loading station 12. The preform feeder 26 may be one of numerous known constructions utilized in the blow molding industry and therefore its full construction is not described in greater detail herein.

From the guide rail 28, the preforms 24 are received by a preform staging mechanism 30 which spaces the preforms 24 such that they may be manipulated by a preform loader 31 and loaded on to carriers 22. The preform staging mechanism 30 utilized in the present invention incorporates a screw drive which engages and intermittently advances a series of preforms 24, six as seen in FIG. 1A. During advancement of the preforms 24 by the screw (not shown) the preforms 24 are appropriately spaced out as required by the preform loading station 12. Various constructions exist for preform staging as will be appreciated by those skilled in the art. It should be understood that the preform staging mechanism 30 illustrated in the blow molding machine 10 could incorporate any of those numerous alternate constructions. Accordingly, the preform staging mechanism 30 need not and is not discussed in further detail.

The preform loading station 12 includes a series of fingers 32 which are advanced by a mechanical cam driven actuator 34 such that the fingers 32 engage the preforms 24 adjacent to the preforms neck finish. The fingers 32 are pivotally connected at their inboard-most end to a frame member 36 of the preform loading station 12, which is mounted for rotation about its longitudinal axis. To enable the fingers 32 to retainingly engage the preforms 24, each set of fingers 32 is biased by a spring 38 into a closed position. On advancement of the fingers 32 by the actuator 34, the fingers 32 contact the preforms 24 and are forced outward against the bias of the spring 38 until they snap around the neck finish 52 of the preform 24. The spring 38 accordingly retains the fingers 32 in a clamping action around the neck finish 52 of the preform 24.

A servo motor 40 then rotates the frame 36 180 degrees about its longitudinal axis, thereby removing the preforms 24 from the preform staging mechanism 30. On the opposing side of the preform loading station 12, as the frame 36 rotates the preforms 24 are brought down by the fingers 32 and mounted upon a series of preform carriers 22. The carriers 22 are themselves held in position as the preforms 24 are engaged therewith at the preform loading station 12 by a preform end 42 of a transfer rake 44 (further discussed below). Once the preforms 24 have been mounted to the carriers 22, the rake 44 is retracted laterally away from the preform loading station 12, releasing the carriers 22, with the preforms 24 mounted thereto, onto the transport conveyor 20. Lateral movement of the rake 44 is accomplished through utilization of an actuator 46, coupled to the rake 44, which may be a pneumatic or other know type of actuator.

While not illustrated in connection with the preform loading station 12, a carrier 22 having a preform 24 mounted thereto is illustrated in FIG. 3 in connection with the thermal conditioning station 14.

The carrier 22 is provided with a one piece construction and is accordingly machined from a single piece of suitable material, such as aluminum. The carrier 22 includes a protruding nipple 48 formed in its upper most surface 50. The outer diameter of the nipple 48 substantially corresponds to the inner diameter of the neck finish 52 of the preform 54. During downward rotation of the preform at the preform loading station 12, by the fingers 32, the neck finish 52 of the preform 24 is brought into engagement over the nipple 48 of the carrier 22. Immediately surrounding the nipple 48 is a recess 54 into which the neck finish 52 descends. An o-ring 56 or other means may be provided in this recess 54 to aid in sealing the carrier 22 and preform 24 during blow molding at the blow molding station 16 (as discussed below). In the illustrated embodiment, the outer diameter of the nipple 48 and the inner diameter of the neck finish 52 are such that the preform 24 is retainingly engaged on the carrier 22. In alternative embodiments of the carrier 22, positive retention means or provisions to assist in retention may be provided. Additional features of the carrier 22 are further described below in connection with the thermal conditioning station 14.

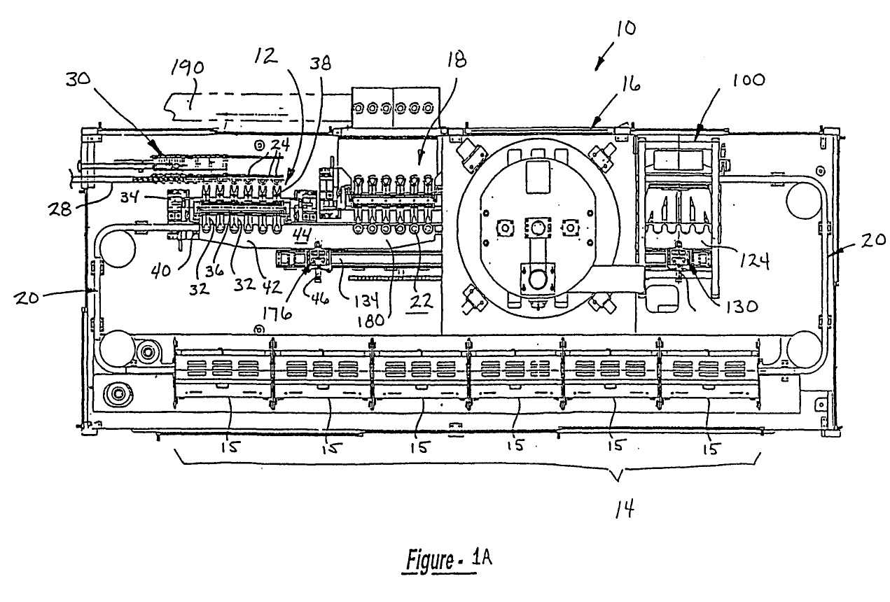

The transport conveyor 20, seen in FIGS. 1 and 2, is illustrated in isolation in FIG. 2. As seen therein, the transport conveyor 20 is an endless conveyor having a sectional belt 58 driven by a driver 60, such as a servo motor. Preferably the belt 58 is constructed of a hard plastic or other material and is sectioned enabling the belt 58 to readily navigate corners 62 as required by the present invention. The belt 58 is retained in its desired configuration by a frame 64 constructed of aluminum or other material and provided on both sides of the belt 58. At its ends 66, the belt 58 is trained back upon itself. In this manner, the return path of the belt 58 is directly beneath the upper surface of the belt 58 and similarly guided by the frame 64. Individual sections of the belt are coupled to adjacent sections in a finger jointed and pivotal manner which allows the belt 58 to readily navigate corners 62 without binding. Such belts are well known in the manufacturing industries and need not be further discussed herein as the full construction will be appreciated by those skilled in the art.

The transport conveyor 20 mentioned above delivers the carriers 22, and the preforms 24 mounted thereon, to the thermal conditioning station 14. The thermal conditioning station 14 includes a plurality of ovens 15 (five in the schematic illustration of FIG. 1 and six in the illustration of FIG. 1A). While illustrated with five and six ovens, the construction of the thermal conditioning station 14 may include a greater or lesser number of ovens 15 depending on the specific design criteria. Additionally, the station 14 may be modular in design allowing ovens 15 to be taken off-line or added on-line, depending on the then current operating conditions of the blow molding machine 10 and the specific design of the machine.

As seen in FIG. 3, each oven 15 includes a housing 68 through which the carriers 22 and preforms 24 are transported at the thermal conditioning station 14. Interiorly of the housing 68, each oven 15 is provided with a plurality of heat lamps 70 which typically extend the length of each oven 15. The heat lamps 70 are mounted within each oven 15 such that their transverse positioning (designated by arrow 71) within the oven 15 relative to the preform 24 maybe adjusted as required by the specific shape of the preform's body 72. As seen in FIG. 3, the transverse positioning of the lamp 70 may be adjusted to conform to the profile of the body 72 of the preform 24. The mounting of such lamps 70 for lateral displacement is common in the industry and, accordingly, is not described in great detail, but typically includes a retainer plate or similar structure 73. The ovens 15 are provided with a reflective surface 74 on a surface opposite the lamps 70. In this manner, the side of the preform 24 opposite the lamps 70, is reflectively heated without the need for additional lamps 70.

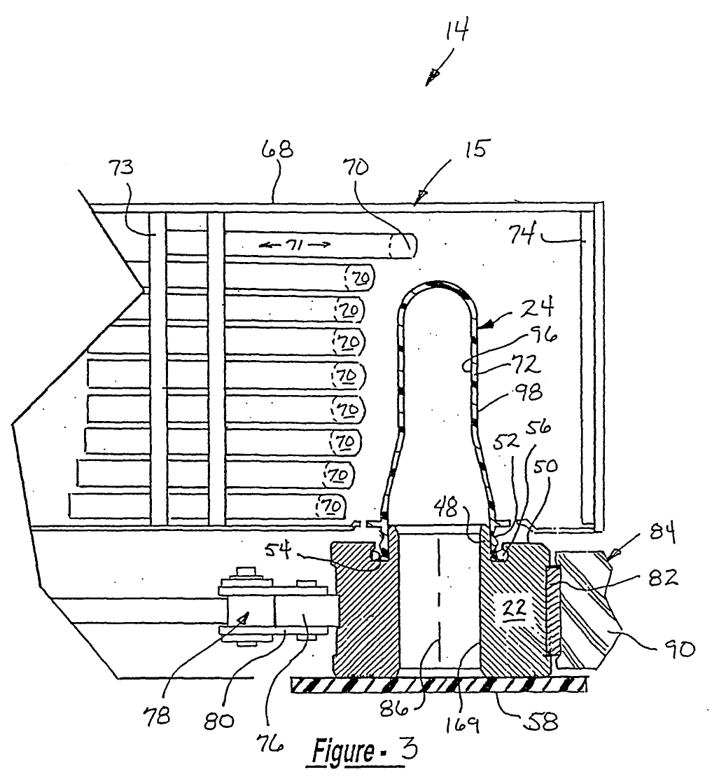

Once entering into the thermal conditioning station 14, the rate of conveyance through the station 14 is no longer governed by the transport conveyor 20 and the rate of the belt 58. Within the thermal conditioning station 14, the carriers 22 are contacted on one side by a plurality of rollers 76 coupled together in a chain conveyor assembly 78 by rigid lengths 80. Opposite the chain conveyor assembly 78, the carrier 22 is engaged by a belt 82 which is part of a rotational conveyor assembly 84. These features and their engagement with the carrier 22 are best seen in FIGS. 3 and 4.

The chain conveyor assembly 78 includes a toothed gear drive 81 and is driven by a servo motor 86. As seen in FIG. 4, a pair of rollers 76 of the chain conveyor assembly 78 engage each carrier on opposing sides of a centerline of the carriers 22. As such, the carrier 22 becomes trapped between the rollers 76 and the belt 82 of the rotational conveyor assembly 84. Movement of the carrier 22 along belt 58 of the transport conveyor 20 is thereafter restricted because of the trapping engagement of the rollers 76 with the carrier 22. Accordingly, when the carriers 22 and preforms 24 are within the thermal conditioning station 14 the chain conveyor assembly 78 determines the rate of conveyance of the carriers 22 through the station 14. This is further permitted because the carriers 22 are not positively or retainingly engaged with the belt 58 and, instead, merely rest on the top surface of the belt 58. When engaged by the chain assembly 78, the belt 58 and the carriers 22 move relative to one another with the belt 58 sliding underneath and ahead of the carriers 22 when the rate of the chain conveyor assembly 78 is less than the rate of the belt 58.

While the carriers 22 are transferred through the ovens 15 at a rate determined by the movement of the rollers 76 in the chain conveyor assembly 78, the rotational conveyor assembly 84 causes the carrier 22 and the preform 24 to additionally rotate about the vertical axis 86 of the carrier 22. The belt 82 of the rotational conveyor assembly 84 extends about a pair of end pulleys 88 and through the entire length of the rotational conveyor assembly 84. A series of tension pulleys 90 are located between the end pulleys 88 and are spring or otherwise biased by biasing mechanisms 91 into contact with the belt 82 thereby forcing the belt 82 into engagement with the carriers 22. For clarity purposes, only a representative number of the tension pulleys 90 are labeled as such in FIG. 4.

The belt 82 is additionally entrained around a drive pulley 92 which is in turn caused to rotate by a servo motor 94. Being provided with its own servo motor 94, the belt 82 of the rotational conveyor assembly 84 is capable of being rotated at a rate and in a direction differing from the rate at which the chain conveyor assembly 78 moves the carriers 22 through the thermal conditioning station 14. As a result, and in conjunction with the rollers 76, the belt 82 causes the carriers 22 and the preform 24 positioned thereon to rotate about their axes 86 as they are transported through the thermal conditioning station 14. As those skilled in the art will appreciate, by rotating the preforms 24 as they pass through the ovens 15, uniform heating of the material forming the body 72 of the preform 24 can be achieved.

Upon exiting the thermal conditioning station 14, the carriers 22 are released by the chain assembly 78 and the rotational conveyor assembly 84 onto the transport conveyor 20. Once again their rate of movement is dictated by the transport conveyor 20 as they freely rest upon the surface of that belt 58.

From the thermal conditioning station 14, the carriers 22 and heated preforms 24 are next transported to the blow molding station 16. The time from which the carriers 22 and preforms 24 exit the thermal conditioning station 14 until they are blow molded in the blow molding station 16 is known as the soak time. Soak time refers to the time available for the temperature of the interior surfaces 96 of the preforms 24 to equalize with the temperature of the exterior surfaces 98 of the preform 24. Depending upon the thickness of the body 72 of the preform 24 and upon the specific material of the preform 24, greater or lesser soak times may be warranted or desired. Additionally, it may be desirable to limit the amount of thermal equalization between the internal and external surface temperatures for reasons related to the article being manufactured.

The machine 10 of the present invention, in addition to allowing for flexible cavitation at the blow molding station 16, allows for a variable soak time. This variability of the soak time is achieved by controlling the servo motor 60 governing the rate of movement of the belt 58. By increasing the speed of the belt 58, soak time can be decreased. Conversely, by decreasing the speed of the belt 58, the soak time may be increased.

As seen in FIG. 4, the rate at which the carriers 22 are transported through the thermal conditioning station 14 is such that the carriers 22 and preforms 24 are located in side by side or immediate adjacent positioning as they progress therethrough. Accordingly, the carriers 22 and preforms 24 exhibit a first preform density as they pass through this thermal conditioning station 14. As the carriers 22 and preforms 24 are released from the chain assembly 78 of the thermal conditioning station 14, movement of the carriers 22 and preforms 24 is again determined by the rate at which the belt 58 is moving. By moving the belt 58 at a rate greater than the rate at which the chain assembly 78 is moving, the carriers 22 and preforms 24 are accelerated out of the thermal conditioning station 14 and are thereafter spaced apart from one another. Accordingly, a second preform density is exhibited as the carriers 22 move with the belt 58.

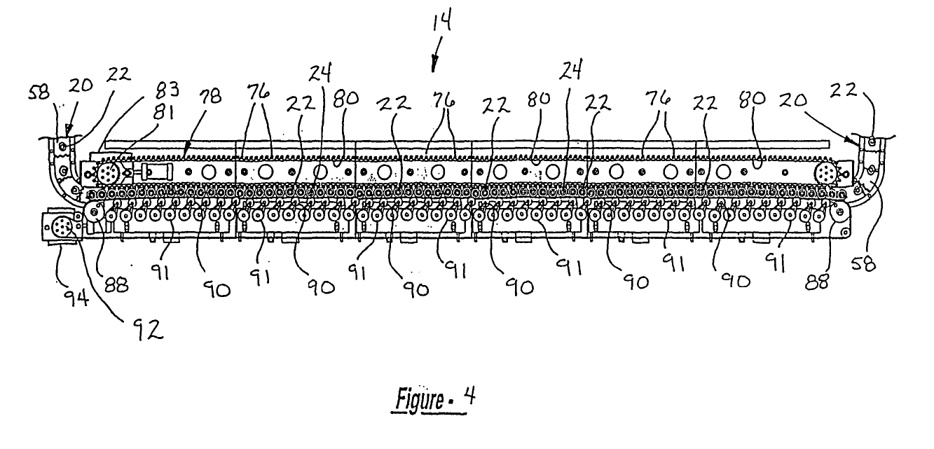

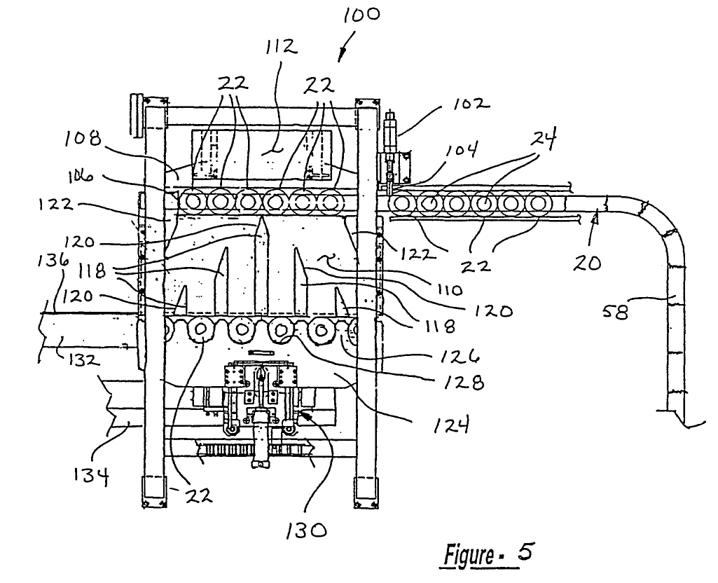

Referring now to FIGS. 5 and 6, prior to moving into the blow molding station 16, the carriers 22 and preforms 24 are transported by the transport conveyor 20 to a preform spreading station 100. At the preform spreading station 100, a pneumatic or other type of actuator 102 advances a finger 104 to interfere with movement of the carriers 22 and preforms 24 by the transport conveyor 20. This may cause a stacking up of the carriers 22 as illustrated in FIG. 5. When the station 100 is clear of already admitted carriers 22, the finger 104 is retracted by the actuator 102 and an appropriate number of carriers, corresponding to the cavitation of the blow molding station 16, are permitted to enter the station 100. These carriers 22 and associated preforms 24 are transported into the station 100 by the transport conveyor 20, which thereafter begins its return path. Within the station 100, the carriers 22 progress along the transport conveyor 20 until contacting a stop surface 106 which limits further travel of the carriers 22. With the appropriate number of carriers 22 admitted into the station 100, the actuator 102 again advances the finger 104 stopping the movement of any additional carriers 22 into the station 100.

With the appropriate number of carriers 22 within the station 100, a push blade 108 is brought into contact with the series of carriers 22 in a direction generally transverse to movement of the transport conveyor 20. As a result of contact with the push blade 108, the carriers 22 and associated preforms 24 are pushed off of the transport conveyor 20 and on to a spreader plate 110. As best seen in FIG. 6, the push blade 108 is supported by a frame 112 coupled to guide rods 114 located above the spreader plate 110. A pneumatic or other type of actuator 116 is additionally coupled to the frame 112 and retraction of the actuator 116 will cause the push blade 108 to be drawn across the transport conveyor 20 pushing the carriers 22 onto the spreader plate 110. In FIG. 6, the frame 112 and push plate 108 are illustrated in both the advanced and retracted positions.

As the carriers 22 are drawn across the spreader plate 110, the carriers 22 engage diverter bars 118 positioned on top of the spreader plate 110. The bars 118, beginning at the mid-point of the series of carriers 22 engage tapered ends 120 of the bars 118 and act to spread out and equidistantly position the carriers 22 relative to one another. This spacing coincides with the cavitation of the blow molding station 16. Stray lateral movement of the carriers 22 is prevented by lateral guides 122 also mounted to the top of the spreader plate 110.

Continued advancement of the push plate 108 moves the carriers 22 into engagement with a transfer rake 124. The transfer rake 124 includes a series of teeth 126 defining recesses 128 therebetween and into which the carriers 22 are received. The centerline spacing of the recesses 128 corresponds with the centerline spacing and cavitation of the blow molding station 16. Once the carriers 22 are fully seated within the transfer rake 124, the actuator 116 moves the frame 112 and the push plate 108 back to its initial position and a new series of the carriers 22 and preforms 24 are admitted into the station 100 for the next cycle.

In an alternative embodiment, the push blade 108 may be of limited stroke so as to move the carriers 22 and preforms 24 off of the conveyor 20 the distance of approximately one carrier width. When subsequent carriers 22 are advanced by the push blade 108, the previously advanced carriers 22 will be in turn moved additionally toward, and eventually into, the transfer rake 124. In doing so, additional soak time can be added to the machine 10.

With the carriers 22 fully seated within the recesses 128 of the rake 124, a linear servo motor 130 is actuated causing the rake 124 to move in a direction transverse to that in which it received the carriers 22. At this point the carriers 22 are slid along a stationary or dead plate 132 located substantially parallel to the guide rail 134 along which the servo motor 130 moves for its linear motion. The stationary plate 132 may include a lip or gib 136 to prevent the carriers 22 from inadvertently moving out of the rake 124 and off of the dead plate 132.

Advancement of the rake 124 as discussed above, moves the carriers 22 and the preforms 24 into the blow molding station 16. Once the carriers 22 and preforms 24 are properly located within the blow molding station 16, a pneumatic or other type of actuator 136 retracts the rake 124 away from the dead plate 132 and the servo motor 130 returns the rake 124 back into the preform spreader station 100. With the rake 124 located back within the preform spreader station 100, the actuator 136 advances the rake 124 back into position where it may receive the next series of carriers 22 as they are spread out or spaced within the station 100.

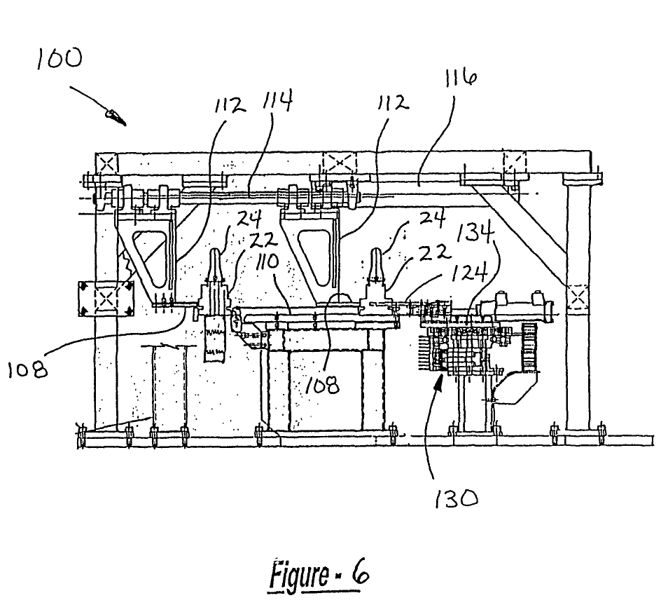

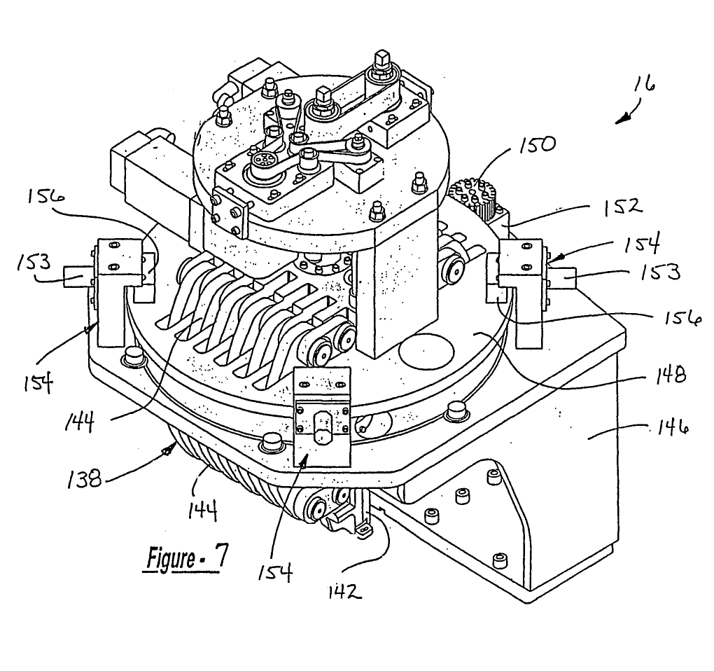

Two major components of the blow molding station 16 are illustrated in FIGS. 7 and 8. More specifically, FIG. 7 illustrates the clamp assembly 138 while FIG. 8 illustrates the stretch rod and blow air assembly 140.

The clamp assembly 138 includes a pair of platens 142 which support the molds (not shown) of the blow molding station 16. Servo driven mechanical linkage 144, coupled to the platens 142, causes the platens 142 to be opened or closed as desired. Obviously, the platens 142 and the molds attached thereto are opened as carriers 22 and preforms 24 are advanced into the blow molding station 16 and as blow molded articles are transported out of the blow molding station 16 on the carriers 22. Many varieties of clamp assemblies are well know in the blow molding art and for this reason those skilled in the art will readily appreciate the features and operation of the present clamp assembly 138. Accordingly, the clamp assembly 138 is not discussed in greater detail herein.

One feature of the clamp assembly 138, which has not been previously seen, allows for movement of the clamp assembly 138 in a manner which more readily facilitates the changing of the molds and therefore the cavitation of the machine 10. Specifically, the clamp assembly 138 includes a stationary frame 146 and a rotatable plate 148.

The platens 142, linkage 144 and all componentry associated with the opening and closing of the molds are carried by the rotational plate 148 which is supported and guided by rollers (not shown) on the stationary frame 146. During operation of the blow molding machine 10, the illustrated linkage 144 is oriented toward the exterior of the machine 10 as seen in FIG. 1A. This orientation of the clamp assembly 138 does not lend itself to easy changing of the molds because the interior faces of the platens 142 are not readily accessible from the exterior of the machine 10 and must be accessed from the side. To alleviate this problem, the clamp assembly 138 of the machine 10 allows for access to the platens 142, linkage 144 and associated componentry through rotation of the rotation plate 148 and these components. By rotating this plate 148 90°, direct and easy access can be gained to the platens 142 from the exterior of the machine 10 since the platens 142 are then oriented such that the opening between them is also open in a direction exteriorly of the machine 10.

Rotation of the plate 148 and the componentry of the clamp assembly 138 mounted thereon can be achieved in various ways including engagement of a tooth drive wheel 150 with a correspondingly tooth portion of the rotational plate 148 and rotation of the drive wheel 150 by an electric motor 152 or other driver. In an alternative embodiment, a belt may be engaged with the rotational plate 148, extending therearound, and driven by a drive pulley and an electric motor (analogous to the drive wheel 150 and motor 152 discussed above). To insure that the rotational plate 148 is fixedly positioned relative to the rigid frame 146 during actual blow molding, a pneumatic or other type of actuator 153 may advance pins (not shown), of a locking assembly 154 rigidly mounted to the frame 146, into engagement with corresponding portions 156 formed in or mounted to the rotational plate 148.

In an alternative embodiment, the clamp assembly 138 may be constructed to slide outward of the machine 10 proper in order to provide access to the platens 142 and molds mounted thereto.

The stretch rod and blow air assembly 140, seen in FIG. 8, includes numerous features which are well know within the industry. For this reason, a construction and working of the stretch rod and blow air assembly 140 need not be discussed in great detail herein. It is noted, however, that all of the stretch rods 162 are simultaneously and commonly advanced during the blow molding of the preforms 24 into articles by advancement of a rack 158 coupled to a moveable belt 160 driven by a motor (not shown) or other driver. During actual blow molding, the frame 164 is raised by pneumatic or other type of actuators 166 bringing blow seals 168 into general engagement with a central bore 169 defined through the carriers 22. The blow seals 168 themselves are pneumatically actuated to sealingly engage the carriers 22. To permit the stretch rods to enter into the bores through the carriers 22, the dead plate 132 is provided with a central slot 171 in a position above the stretch rod and blow air assembly 140. As seen in FIG. 8, the blow seals 168 are individually carried on blow manifolds 170 that can be readily repositioned in the frame 164, depending upon the cavitation of the blow molding station 16. Removable pins 172 are illustrated for this purpose. While it is anticipated that each manifold 170 will be individually supplied with blow air, a common supply could similarly be used.

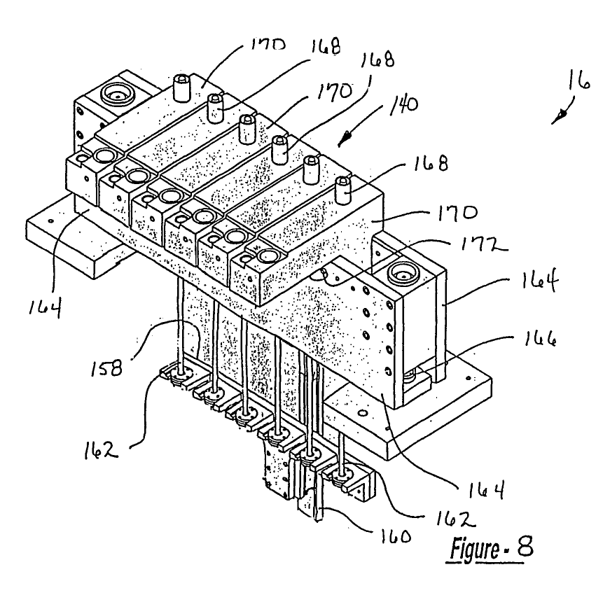

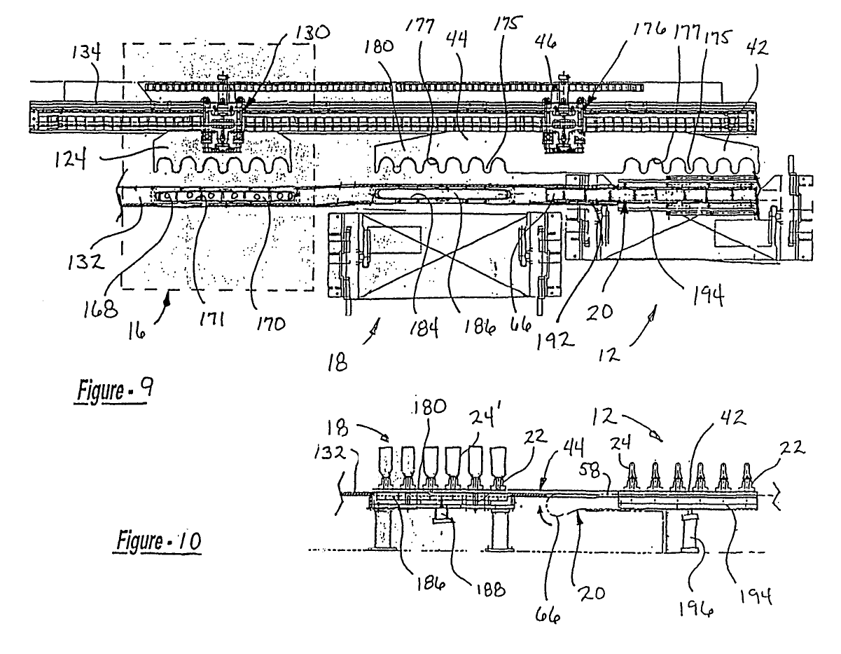

In order to transfer carriers 22 and blow molded articles 24′ thereon out of the blow molding station 16, a second transfer rake 44 is used. Transfer rake 44 is illustrated in FIGS. 9 and 10 in connection with the blow molding station 16, the article unloading station 18 and the preform loading station 12. These two views of the apparatus differ from those presented previously as in FIG. 5, in that the machine 10 is viewed from the opposing side.

As with the transfer rake 124, the transfer rake 44 is mounted and rides upon the guide rail 134 for a reciprocating movement between the blow molding station 16 and the article unloading station 18 and the preform loading station 12. Also like the prior transfer rake 124, the transfer rake 44 is moved along the guide rail 134 by a linear servo motor 176 appropriately coupled thereto. The transfer plate 44 is coupled to the servo motor 176 such that the transfer rake 44 can be retracted from and advanced toward the dead plate 132 and the transport conveyor 20. In this regard, an actuator 46 similar to actuator 136 is provided and coupled to the transfer rake 44.

In its retracted position, the transfer rake 44 is moved by the servo motor 176 such that an article end 180 of the transfer rake 44 is located within the blow molding station 16 and a preform end 42 of the transfer rake 44 is located at the article unloading station 18. Such a position would be located to the right of that illustrated in FIG. 9. Actuator 46 then advances the transfer rake 44 such that the respective teeth and recesses of the transfer rake engage carriers 22 in the blow molding station 16 and in the article unloading station 18. Once the articles 24′ have been blow molded at the blow molding station 16 and the previously blow molded articles 24′ have been removed from the carriers 22 at the article unloading station 18, the servo motor 176 shifts the transfer rake 40 such that the article end 180 is re-positioned at the article unloading station 18 and the preform end 42 is re-positioned at the preform loading station 12. Once the articles 24′ have been removed from the carriers 22 at the article unloading station 18 and preforms 24 have been loaded onto the carriers 22 at the preform loading station 12, the actuator 46 retracts the transfer rake 44 beginning a repeating of the cycle described above. At the article unloading station 18 and as seen in FIG. 10, the dead plate 132 is again formed with a slot 184. Positioned within the slot 184 is a plate 186 coupled to a pneumatic or other type of actuator 188 which operates to raise the plate 186 into engagement with the bottom surfaces of the carriers 22 being held at the article unloading station 18 by the article end 180 of the transfer rake 44. Preferably the actuator 188 is pneumatically actuated, but other methods of actuation may be utilized.

It is preferred that linear servo motor 130 and linear servo motor 176 are independently operable and controllable from one another. In this way advancement of the carriers 22 and preform 24 toward the blow molding station 16 can begin before the molded articles 24′ and carriers 22 are removed therefrom. In this manner, cycle time of the machine 10 can be further optimized.

The mechanism utilized at the article unloading station 18 may be substantially similar to the mechanism utilized at the preform loading station 12 except that the mechanism would generally be operated in reverse order and further a cam assembly would be utilized to force open the fingers of the mechanism as they are advanced while holding the articles 24′ This opens the fingers and releases the blow molded article 24′ onto an outfeed conveyor 190 (seen in FIG. 1A).

Additional features of the preform unloading station 12 are also illustrated in FIGS. 9 and 10. One illustrated feature is the interplay of the dead plate 132 and the transport conveyor 20. At the end of the transport conveyor 20 where the belt 58 has completed its return path, the belt 58 returns to its top surface position by returning up through a fork 192 in the end of the dead plate 132. Additionally, in order to secure the carriers 22 during mounting of the preforms 24 thereon, a pair of rails 194 are located outboard of the belt 58 and over which the carriers 22 are held by the preform end 42 of the transfer rake 44. The rails 194 are mounted to be raised by a pneumatic or other type of actuator 196 thereby retainingly holding the carriers 22 between the rails 194 and the preform end 42 of the transfer rake 44.

The foregoing discussion discloses and describes one preferred embodiment of the invention. One skilled in the art will readily recognize from such discussion, and from the accompanying drawings and claims, that changes and modifications can be made to the invention without departing from the true spirit and fair scope of the invention as defined in the following claims. The invention has been described in an illustrative manner, and it is to be understood that the terminology which has been used is intended to be in the nature of words of description rather than of limitation.

1. A two-step blow molding machine for blow molding articles from preforms, said machine comprising:
a plurality of stations including a preform loading station where preforms are loaded into said machine, a thermal conditioning station having at least one oven where preforms are heated and thermally conditioned prior to blow molding, a blow molding station where preforms are blow molded into articles and having a plurality of molds the number of which defines the cavitation of said blow molding station, and an article unloading station where blow molded articles are removed from said machine;
a plurality of carriers adapted to receive the preforms thereon at said preform loading station;
a first conveyor and associated driver adapted to convey said carriers through said thermal conditioning station at a first rate;
a second conveyor and associated driver adapted to convey said carriers from said thermal conditioning station to said blow molding station at a second rate; and
said first and second conveyors and associated drivers being independently controllable from one another such that said first and second rates are independently variable, whereby said first and second rates being independently variable enables said cavitation of said blow molding machine to be changed to another cavitation without requiring changes in construction of said first and second conveyors.

2. A blow molding machine according to claim 1 further comprising a rotation conveyor and associated driver rotating said carriers at a rotation rate during conveying thereof through said thermal conditioning station.

3. A blow molding machine according to claim 2 wherein said rotation conveyor and associated driver are independently controllable from said first and second conveyors and associated drivers such that said rotation rate is independently variable from said first and second rates.

4. The blow molding machine according to claim 2 further comprising a third conveyor and associated driver conveying said carriers into said blow molding station at a third rate.

5. The blow molding machine according to claim 4 wherein said third conveyor and associated driver are independently controllable from said first, second and rotation conveyors and associated drivers such that said third rate is independently variable from said first, second and rotation rates and said cavitation of said machine is changeable to another cavitation.

6. The blow molding machine according to claim 1 further comprising a third conveyor and associated driver conveying said carriers into said blow molding station at a third rate.

7. The blow molding machine according to claim 6 wherein said third conveyor and associated driver are independently controllable from said first and second conveyors and associated drivers such that said third rate is independently variable from said first and second rates.

8. The blow molding machine according to claim 1 wherein said first conveyor conveys said carriers through said thermal conditioning station at a first carrier density and said second conveyor conveys said carriers from said thermal conditioning station to said blow molding station at a second carrier density.

9. The blow molding machine according to claim 8 wherein said first carrier density is greater than said second carrier density.

10. A two-step blow molding machine for blow molding articles from preforms, said machine comprising:
a plurality of stations including a preform loading station where preforms are loaded into said machine, a thermal conditioning station having at least one oven where preforms are heated and thermally conditioned prior to blow molding, a blow molding station having a plurality of molds the number of which defines the cavitation of said blow molding station where preforms are blow molded into articles, and an article unloader station where blow molded articles are removed from said machine;
a plurality of carriers adapted to receive the preforms thereon at said preform loading station;
a first conveyor conveying said carriers through said thermal conditioning station; and
a second conveyor and associated driver conveying said carriers from said thermal conditioning station to said blow molding station at a rate defining a soak time, said second conveyor and associated driver being independently controllable to vary said rate and to thereby vary said soak time prior to delivery of said carriers and the preforms to said blow molding station.

11. A blow molding machine according to claim 10 wherein said first conveyor is a belt conveyor.

12. A blow molding machine according to claim 10 wherein said carriers rest upon said belt conveyor.

13. In a thermal conditioning station of a blow molding machine, said station comprising:
a plurality of heating elements;
a housing enclosing said heating elements;
a first conveyor and associated driver adapted to convey preforms at a conveyance rate through said station and adjacent to said heating elements; and
a second conveyor and associated driver adapted to rotate said preforms at a rotation rate as said preforms are conveyed through said station.

14. A thermal conditioning station according to claim 13 wherein said first conveyor includes a pair of engagement members, said engagement members engaging a carrier upon which a preform is supported, said engagement members contacting said carrier on opposing sides thereof and causing translational movement of said preforms.

15. A thermal conditioning station according to claim 13 wherein said engagement members are rollers.

16. A thermal conditioning station according to claim 15 wherein said rollers rotate about a substantially vertical axis.

17. A thermal conditioning station according to claim 14 wherein pairs to said engagement members are coupled together at fixed intervals.

18. A thermal conditioning station according to claim 17 wherein said pairs are coupled together by a chain.

19. A thermal conditioning station according to claim 13 wherein said second conveyor includes an endless belt engaging a carrier upon which a preform is supported, said belt being rotated at a belt rate and said belt rate being different from said conveyance rate.

20. A thermal conditioning station according to claim 19 wherein said belt rate differs in magnitude from said conveyance rate.

21. A thermal conditioning station according to claim 19 wherein said belt rate differs in direction from said conveyance rate.

22. A thermal conditioning station according to claim 15 wherein said second conveyor includes an endless belt engaging a carrier upon which a preform is supported, said belt being rotated at a belt rate and said belt rate being different from said conveyance rate.

23. A thermal conditioning station according to claim 22 wherein said belt rate differs in magnitude from said conveyance rate.

24. A thermal conditioning station according to claim 22 wherein said belt rate differs in direction from said conveyance rate.
